(19) United States
(12) Patent Application Publication
(10) Pub. No.: US 2014/0304608 A1
(43) Pub. Date: Oct. 9, 2014

(54) Method of Operating a Service Provider Management System

(71) Applicant: WESTERGAARD MANAGEMENT A/S, Frederiksberg (DK)

(72) Inventor: Ole Westergaard, Lyngby (DK)

(73) Assignee: Westergaard Management A/S, Frederiksberg (DK)

(21) Appl. No.: 13/856,526

(22) Filed: Apr. 4, 2013

(51) Int. Cl. H04L 12/24

(52) U.S. Cl. CPC H04L 41/22
USPC 715/738

(57) ABSTRACT

A method of operating service provider management systems using a content-control and nudging based process to ensure quality and facilitate knowledge build-up and a computer-based service provider management system configured to support the method.

### FIELD OF THE INVENTION

The present invention relates to a method of operating service provider management systems using a content-control and nudging based process to ensure quality and facilitate knowledge build-up. Further, the invention relates to a computer-based service provider management system configured to support such a method.

### BACKGROUND OF THE INVENTION

Before the method and computer based system of the present invention there was no method or computer-based system using a content-controlled and nudging based process to ensure quality and knowledge build-up that is independent of subsequent quality control and knowledge collection within service provider management organizations. Conventionally such systems has been developed based on best practice frame processes to create an environment of processes and systems for carrying out case management in the best possible way. However, such systems lack the ability to effectively control the system of the case management based on effective processes based on competences and experience due to the complexity of such systems. Thus a need exists to provide a case management system with improved process control to ensure high quality management of service requests in service provider management organizations.

### DISCLOSURE OF THE INVENTION

On this background, it is an object of the present application to provide a method of operating a service provider management system wherein the workflow when handling a service request is controlled through a set of operational standard processes prompted systematically in a specific order to ensure that users of the service provider management system provides the information intended in the design of the system to achieve the highest possible quality of the service requests handled by the service provider management system.

This object is achieved by providing a method of operating a service provider management system having an operator interface and an input component, said method comprising the steps of:
receiving a service request in the system from a requestor being serviced by a service provider;
allocating a portion of the operator interface to a set of predefined logging input fields comprising a set of mandatory logging input fields;
prompting an operator to input or select facts relating to the service request in the logging input fields;
verifying that mandatory logging input fields has been completed before allowing the next step to be initiated;
thereafter allocating said portion of the operator interface to a set of predefined initial diagnosis input fields, said set of predefined initial diagnosis input fields comprising mandatory initial diagnosis input fields;
prompting an operator to input or select an initial diagnosis in the set of initial diagnosis input fields;
verifying that the mandatory initial diagnosis input fields have been completed;
thereafter allocating said portion of the operator interface to a set of predefined diagnosis output fields, said set of predefined diagnosis output fields comprising mandatory diagnosis output fields;
prompting an operator to input or select a diagnosis output in the set of diagnosis output fields;
verifying that the mandatory diagnosis output fields have been completed;
issuing a service request reply comprising the diagnosis output;
thereafter allocating the portion of the operator interface to a set of closure fields comprising mandatory closure fields;
prompting an operator to input or select facts relating to closure in the set of closure fields;
verifying that the mandatory closure fields have been completed;
closing the service request; and
outputting the facts from the mandatory closure fields to a database.

In an embodiment of the method according to the invention, the step of allocating a portion of the operator interface to a set of predefined logging input fields comprising a set of mandatory logging input fields further comprises the steps of:
prompting an operator to input or select a service request category;
verifying that the service request category has been input or selected, and
defining a sequence of the set of predefined logging input fields based on the service request category.

By initially selecting a service request category the workflow may be tailored to the exact service request type, such that the user only has to acknowledge the relevant input fields or have access to additional tools such as category specific dropdown lists or search tools.

In an embodiment the method according to the invention, the service request category is an incident management, a transition management, knowledge management, change management or a request management.

In an embodiment the method according to the invention, the service request category is a change management, a request fulfillment management or an access management.

In an embodiment of the method according to the invention, one or more of the steps of prompting an operator to input or select facts, an initial diagnosis, a diagnosis output or facts relating to closure further comprises the step of:
nudging the operator to input or select one or more mandatory or optional fields.

The mandatory input fields required by the system to be input may be further supported to achieve the highest possible quality of the service request management and therefore the method may also comprise a step of nudging the user to input optional fields to increase the quality. Even the step of inputting mandatory input fields may comprise a step of nudging the user e.g. to a specific type of input again to increase the quality of the handling of the service request or to improve the efficiency by which service requests are handled by the method according to the invention.

In an embodiment of the method according to the invention, the step of nudging the operator to input or select one or more optional fields comprises prompting the operator with information from earlier similar service requests to lessen the burden of inputting or selecting one or more optional fields thereby improving quality of the operator input.

An effective nudging step is the prompting of one or more earlier inputs in a specific input field to allow the user to get an idea of the type of input relevant in the input field e.g. length and content of the input.

In an embodiment of the method according to the invention, the step of nudging the operator to input or select one or more mandatory or optional fields comprises prompting the operator with a direct link to a knowledge database to allow the operator quickly to seek information to lessen the burden of inputting or selecting one or more optional fields thereby improving quality of the operator input.

Quick access to a knowledge database may nudge the user to seek information from earlier or similar service requests, which in effect again increases the quality in the handling of the service request.

In an embodiment of the method according to the invention, the step of nudging the operator to input or select one or more mandatory or optional fields comprises prompting the operator with information from earlier service requests to lessen the burden of inputting or selecting one or more optional fields thereby improving quality of the operator input.

In an embodiment of the method according to the invention, the step of allocating a portion of the operator interface to a set of predefined logging input fields comprising a set of mandatory logging input fields further comprises the step of:
displaying in the central portion facts from one or more similar service requests in the same service request category.

In an embodiment of the method according to the invention, the method further comprises the steps of:
prioritizing the service request by a service request priority;
forwarding the service request to a buffer list of service requests;
displaying a service request having the highest priority in the central portion.

In an embodiment of the method according to the invention, the step of allocating said portion of the operator interface to a set of predefined initial diagnosis input fields comprises the steps of:
allocating a field for a symptom associated with a problem of the service request;
allocating a field for a triggering factor of the symptom associated with the problem.

In an embodiment of the method according to the invention, the method further comprises the step of prompting the operator to input or select which inputting fields associated with logging, initial diagnosis, diagnosis output or closure are relevant to future service requests such that the input or selected information from the operator may be made available in a knowledge database.

In an embodiment of the method according to the invention, the operator is prompted to tick off fields of relevance in a tick box associated with each fields, thereby indicating fields which are relevant to future service requests such that the ticked input from the operator may be made available a knowledge database.

In an embodiment of the method according to the invention, the step of allocating said portion of the operator interface to a set of predefined diagnosis output fields further comprises the step of:
allocating a direct link to a knowledge database in the portion of the operator interface.

In an embodiment of the method according to the invention, the step of allocating the portion of the operator interface to a set of closure fields comprising mandatory closure fields further comprises the step:
allocating a field for a case summary.

In an embodiment of the method according to the invention, the steps of verifying that the mandatory logging fields, mandatory initial diagnosis fields, diagnosis output fields has been completed comprises a step of prompting to the operator that the service request cannot be issued before the mandatory fields has been completed.

In an embodiment of the method according to the invention, the step of allocating the portion of the operator interface to a set of closure fields comprises the step of:
allocating a field for a list of open service request having matching or near matching symptoms or triggering factors of the symptoms of a problem of the service request for allowing the operator to solve similar service requests while having the service request and diagnosis steps fresh in mind.

In an embodiment of the method according to the invention, the allocation of said portion of the operator interface is shown on a graphical user interface on a computer screen and said operator input component comprises a keyboard.

In an embodiment of the method according to the invention, the input or selection values of a service request already known in the service management system are automatically discarded and thus not prompted to be input by the operator.

The object above is also achieved by providing a computer-based service provider management system comprising:

an operator interface and an input component;

a processor being configured to control operation of said system including being configured to receive input from an operator through the input component, and to run an application on said system;

said processor further being configured to receive a service request in the system from a requestor being serviced by a service provider;

said processor further being configured to allocate a portion of the operator interface to a set of predefined logging input fields comprising a set of mandatory logging input fields;

said processor further being configured to prompt an operator to input or select facts relating to the service request in the logging input fields;

said processor further being configured to verify that mandatory logging input fields has been completed before allowing the next step to be initiated;

said processor further being configured to thereafter allocate said portion of the operator interface to a set of predefined initial diagnosis input fields, said set of predefined initial diagnosis input fields comprising mandatory initial diagnosis input fields;

said processor further being configured to prompt an operator to input or select an initial diagnosis in the set of initial diagnosis input fields;

said processor further being configured to verify that the mandatory initial diagnosis input fields have been completed;

said processor further being configured to thereafter allocate said portion of the operator interface to a set of predefined diagnosis output fields, said set of predefined diagnosis output fields comprising mandatory diagnosis output fields;

said processor further being configured to prompt an operator to input or select a diagnosis output in the set of diagnosis output fields;

said processor further being configured to verify that the mandatory diagnosis output fields have been completed;

said processor further being configured to issue a service request reply comprising the diagnosis output;

said processor further being configured to thereafter allocate the portion of the operator interface to a set of closure fields comprising mandatory closure fields;

said processor further being configured to prompt an operator to input or select facts relating to closure in the set of closure fields;

said processor further being configured to verify that the mandatory closure fields has been completed;

said processor further being configured to close the service request.

The invention also relates to a computer-based service provider management system comprising a processor configured to control a set of service requests.

Also, in an embodiment of the system according to the invention, the processor is furthermore configured to categorize the service request by a service request category and configured to define a sequence of the set of predefined logging input fields based on the service request category.

Also, in an embodiment of the system according to the invention, the processor is furthermore configured to display in the central portion facts from one or more similar service requests in the same service request category during allocation of the central portion of the predefined area of the operator interface to the set of predefined logging input fields.

Also, in an embodiment of the system according to the invention, the processor is configured to prioritize the service request by a service request priority, forward the service request to a buffer list of service requests and display a service request having the highest priority in the central portion.

Also, in an embodiment of the system according to the invention, processor is configured to prioritize the service request by a service request priority, forward the service request to a buffer list of service requests and display a service request having the highest priority in the central portion.

Also, in an embodiment of the system according to the invention, the processor is configured to allocate a field for a symptom of a problem of the service request and allocate a field for a triggering factor of the symptom of the problem during allocation of the central portion to the set of predefined initial diagnosis input fields.

Also, in an embodiment of the system according to the invention, the processor furthermore is configured to receive inputs from of the operator, when the operator is inputting in fields associated with logging, initial diagnosis, diagnosis output or closure, the inputs indicating fields which are relevant to future service requests such that the indicated input from the operator may automatically enter a knowledge database.

Also, in an embodiment of the system according to the invention, the processor furthermore is configured to receive inputs from of the operator, when the operator is inputting in fields associated with logging, initial diagnosis, diagnosis output or closure, said processor being configured to receive an operator ticking off fields indicating fields which are relevant to future service requests in a ticking box associated with each field such that the ticked input from the operator may automatically enter a knowledge database.

Also, in an embodiment of the system according to the invention, the processor is configured to allocate a direct link to a knowledge database in the central portion during allocation of the central portion to a set of diagnosis output fields.

Also, in an embodiment of the system according to the invention, the processor is configured to allocate a field for a case summary during allocation of the central portion to a set of diagnosis output fields.

Also, in an embodiment of the system according to the invention, the processor is configured to allocate a field for a list of open service request having matching or near matching symptoms or triggering factors of the symptoms of a problem of the service request during allocation of the central portion to a set of closure fields.

Also, in an embodiment of the system according to the invention, the processor is configured to give access to input data from a set of fields having been recognized by a control procedure during subsequent steps.

Further objects, features, advantages and properties of the engine and method of operating an engine according to the present disclosure will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 depicts a flow-chart diagram of an embodiment of a process flow of processing a service request,

FIG. 2a is a flow-chart diagram of a subroutine of the method shown in FIG. 1,

FIG. 2b is a flow-chart diagram of a subroutine of the method shown in FIG. 1,

FIG. 2c is a flow-chart diagram of a subroutine of the method shown in FIG. 1,

FIG. 2d is a flow-chart diagram of a subroutine of the method shown in FIG. 1,

FIG. 3 is a flow-chart diagram of a subroutine,

FIG. 4 is a flow-chart diagram of a subroutine,

FIG. 5 is a schematic overview of a service provider management system,

FIG. 6 is a screen shot of an operator interface having a central portion display allocated to a set of predefined logging input fields of an electronic processing unit,

FIG. 7 is a screen shot of an operator interface having a central portion display allocated to a set of predefined initial diagnosis input fields of a processing unit,

FIG. 8 is a screen shot of an operator interface having a central portion display allocated to a set of predefined diagnosis output fields of a processing unit, and

FIG. 9 is a screen shot of an operator interface having a central portion display allocated to a set of set of closure fields of a processing unit.

### DETAILED DESCRIPTION OF PREFERRED EMBODIMENTS

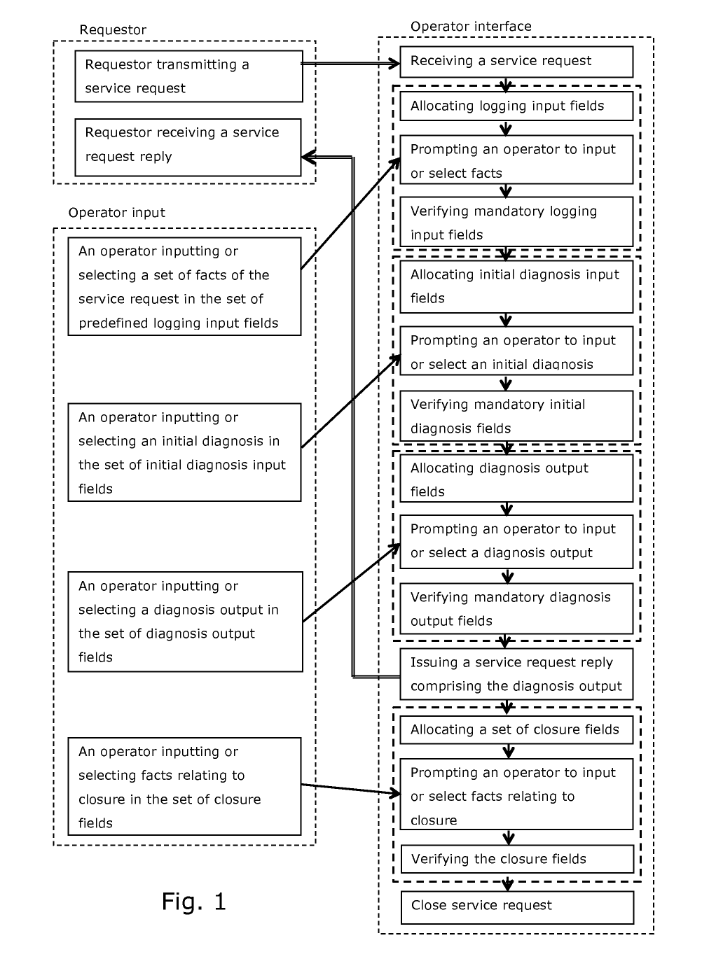

FIG. 1 is a flow-chart diagram of an embodiment of the present invention. FIG. 1 shows a preferred embodiment of the invention wherein the sequence created is preferably created for processing a service request using a service provider management system.

Initially a requestor transmits a service request to the service provider management system. The service request may be any type of service request managed by service provider management systems such as incident managements e.g. software failures, hardware failures, network problems etc. Incident refers to a problem in an existing IT solution. IT departments typically follow more or less the same procedures or lack of procedures when dealing with incidents irrespective of the type of incident, since the process is set out by the service provider management system of the IT or managing departments. Other types of service requests may relate to transition management i.e. the change of existing settings, hardware etc. and the deployment of such. Specific requests in transition management are requests related to release management e.g. related to release, deployment or roll-out of new software or hardware solutions. Other Specific requests in transition management are requests related to changes in standards e.g. related to release, deployment or roll-out of new software or hardware solutions according to new standards. The service request may also relate to knowledge management i.e. the request of a known knowledge item based on prior experience or the request of providing a new knowledge item to solve e.g. a recurring problem etc. The service request may also relate to request management i.e. procedures around the request of new items e.g. new hardware, new software etc. According to the method of the current invention all types of service requests are dealt with using the same generic approach, but the specific handling of different types of service requests may of course be made to depend on the specific type of service request using different subroutines or skipping steps of the method not appropriate to the specific service request.

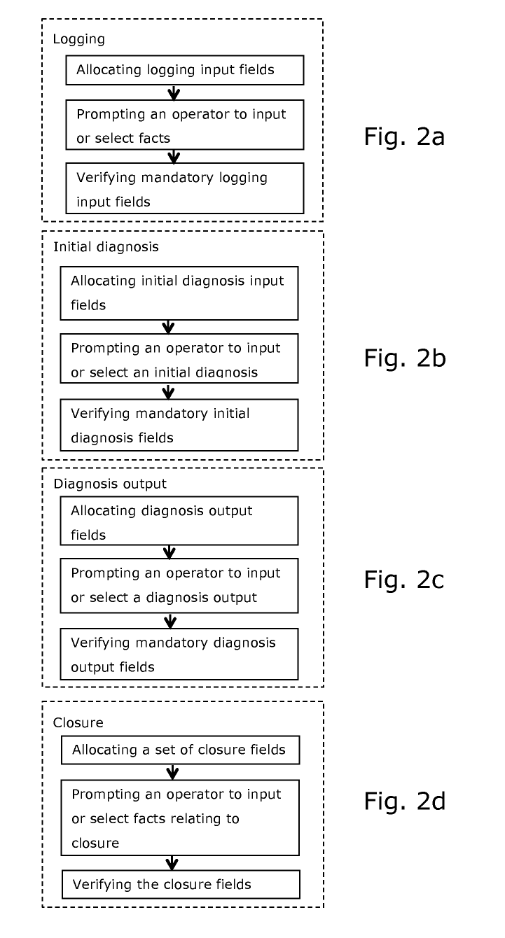

The service request is received at an operator interface, the service provider management system typically a service provider management system application running on a computer. When the service request is received at the operator interface a set of predefined logging input fields comprising a set of mandatory logging input fields are allocated on a portion of the operator interface. By allocating a portion of the operator interface, the attention of the operator is directed towards a specific set of fields requiring input. The operator is subsequently prompted to input or select facts relating to the service request in the logging input fields. It is an essential aspect of the method, that the operator is prompted to input the facts relating to the current step in the method, to ensure that the service provider management system supports the operator in achieving a specific focus on the current step rather than a later step e.g. showing fields for inputting the solution to the problem. By allocating a portion and preferably a large and central portion of the operator interface to fields of the current logging step i.e. the logging input fields and prompting the operator to input or select facts from the service request in the logging input fields, the quality of the logging of the service request may be controlled. By adding furthermore a step verifying that mandatory logging input fields has been completed before allowing the next step to be initiated, the service provider management system is setup to ensure that the quality of the logging of the facts of the service request is always performed to a required extent. This logging subroutine also shown in FIG. 2a shows the generic approach of the method i.e. to encourage and nudge the operator to always fill out mandatory operator input, by sequencing the subroutines in an allocation step, a prompting step and a verification step.

Following the logging subroutine (see FIG. 2a) are an Initial diagnosis subroutine (see FIG. 2b), a Diagnosis output subroutine (see FIG. 2c) and a Closure subroutine (see FIG. 2d) all having the same structure as the logging subroutine shown in FIG. 2a of an allocation step, a prompting step and verification step. When the operator is prompted to input or select certain types of information into a set of fields allocated in a portion of the operator interface and the next set of input fields only may be allocated after the fulfillment of at least the mandatory fields, the working process of the operator may be controlled by the service provider management system and not the individual routines of the operator. This significantly enhances the quality of the handling of service requests. Furthermore, the operator may be prompted to use existing knowledge of earlier service requests based on prior input in the service provider management system. Also, the operator may be nudged to fill out non-mandatory fields to improve the quality of the handling of the service request e.g. if the service request regards a computer break down, it might be mandatory to the operator to provide the requestor with a recovery procedure to recover the computer, but the operator may be nudged to inform the requestor of improved back-up procedures to avoid data loss during future computer break downs. This type of nudge may be based on earlier and similar service requests being prompted to the operator, while being prompted to fill out any mandatory fields.

Referring now to FIG. 1 again the portion of the operator interface is subsequent to the verification of the filling of mandatory logging fields allocated to a set of predefined initial diagnosis input fields. When handling service requests of different types in a service provider management system the step of performing an initial diagnosis is very important. The initial diagnosis ensures that the type of service request is determined.

As a result of the input in the initial diagnosis fields the service request may be in some instances be treated as a quick case i.e. a service request which might be dealt with very quickly e.g. due to a prior solution to precisely the same type of service request or if the service request based on the input is found to be very minor. In such cases subsequent steps or input may be automatically input or automatically skipped to reduce time consumption of such cases. Also steps later in the method e.g. diagnosis output steps or closure steps may be automatically input or automatically skipped based on earlier input in order to handle such service requests as quick cases.

Service request management may be improved by requiring prioritization input e.g. during the initial diagnosis or diagnosis output steps. Prioritization of the service requests may in some cases be handled well by an operator performing the initial diagnosis, however, in some cases the severity of the service request are not properly assessed before an expert handles the request later in the process. Therefore, prioritization of the service requests may be performed advantageously during one or more subroutines to ensure an optimal prioritization if initial prioritizations are inadequate.

Prioritizations may be used to escalate processes or routines and operators inputting complementary information may also be viewed as a prioritizing step since the input may escalate the processes or routines based on the input.

The operator is not necessarily a person but may be a group of persons. The work flow for the operators may be such that all operators participate in the initial logging steps i.e. inputting or selecting the facts related to the service request, whereas the initial diagnosis and subsequent steps may only be dealt with by operators handling a specific type of service requests.

The operator may during the logging subroutine or the initial diagnosis subroutine accept the task of handling the service request if he feels competent. Also, the initial diagnosis may be performed by an operator executive of a group of operators and comprise a step of selecting a specific operator to handle the service request.

The basic work of handling the service request to be able to provide the requestor with a service request reply is carried out during the Diagnosis output routine. The diagnosis output fields comprise the mandatory diagnosis output fields which are essential when making a reply to the service request e.g. in a request management examples of mandatory diagnosis output fields could be: is the request of the requested item granted, is the requested item ordered, when is the expected delivery of the requested item etc. When all mandatory diagnosis output fields have been input or selected by the operator, a service request reply may be issued to the requestor.

When the service request reply has been issued to the user to the requestor the portion of the operator interface is allocated to a set of closure fields comprising mandatory closure fields. The operator is prompted to input or select facts relating to closure in the set of closure fields. This step of handling service requests is often neglected since the requestor has already received a response. In periods of high activity the operator therefore tends to neglect the closure of the handling of the service request. However, for the service provider the closure step is often essential to ensure a high level of quality in the handling of service requests and furthermore from a system point of view a time saver since future service requests are better and quicker handled if relevant details on solutions or problems are well handled in the closure steps. When the operator has input or selected at least the mandatory closure fields the mandatory closure fields are verified by the system and the service request is finally closed.

As shown in FIG. 2a-2d the method shown in FIG. 1 comprise four different generic subroutines: Logging FIG. 2a, Initial diagnosis FIG. 2b, Diagnosis Output FIG. 2c and Closure FIG. 2d. Each of these subroutines comprises at least the same generic steps of allocating a set of input fields in a portion of the operator interface, prompting the operator to input and select facts and subsequently verifying that the mandatory fields have been completed. This construction of the subroutines provides a method of operating a service provider management system, where the operator is continuously prompted to have the “right mindset” of his current task. Furthermore, is he not only prompted continuously to have the “right mindset”, but the subroutine also verifies if the operator made the required input in at least the mandatory fields to ensure a high quality in the handling of service requests. The steps of consecutively going through such subroutines as shown in FIGS. 2a-d resemble a user interface of a GPS device used in cars for determining the route of travel. The user interface keeps changing view to be exactly the extract of the route directly in front of you. The mindset of the driver is controlled by only showing the upcoming part of the route and only indicating when and where the next turn is located. In this way the mindset of the driver is controlled to focus only on the upcoming navigation and not give the next navigation command until the driver carried out the former.

Initially an operator inputs or selects a set of facts relating to the service request e.g. facts of an incident or transition. The input to the logging routine as shown in FIG. 1 is typically performed by the operator of the service provider management system, since the operator is the professional compared to the requestor. The requestor may however be forced to input the service request in a specific form to ease the work of the operator, where after the operator checks the input or selection of the requestor.

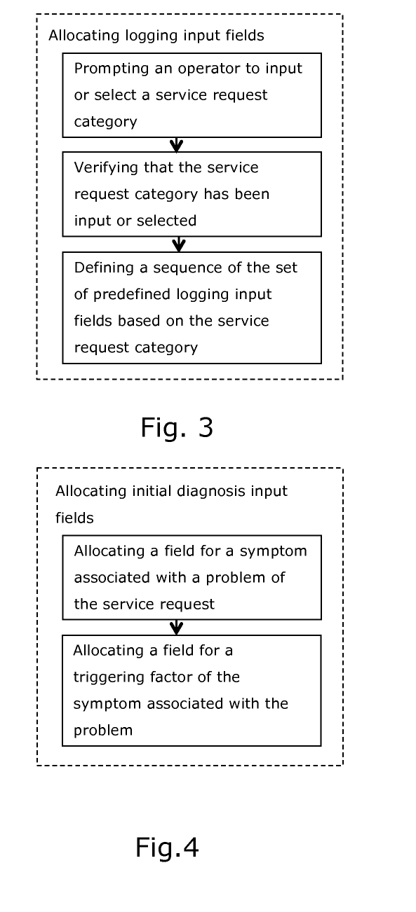

FIG. 3 shows an embodiment according to the invention wherein the step of allocating logging input fields comprises three steps in order to specifically base the input fields and the sequence of the input fields using a specific subroutine. When allocating the logging input fields according to this embodiment the operator is initially prompted to select the service request category, the selection is subsequently verified and the sequence of the logging input fields is thereafter defined based on the service request category. To allow the method of operating the service provider management system to be able to operate various categories of service requests within the same system and still maintain tailored processes and subroutines for different categories of service requests, the service request category may be required as input during the initial logging of the service request. Same approach may be used to differentiate different subcategories of service requests in any other step of the method, e.g. when the service request regards an incident management, the service request category may be chosen during the step of allocating the logging input fields to be in an “incident management” category, and then subsequently the system may require the operator to input a subcategory during the initial diagnosis step e.g. handling of a “hardware failure” subcategory and maybe even further categorized e.g. during the diagnosis output step to a more narrow subcategory e.g. “switch failure”, “hard disc failure” etc.

In some service request management systems operators inputting e.g. the initial diagnosis may not have sufficient knowledge to reach the conclusions or even the right field of the diagnosis output resolution, since these may require deeper insights into some details not available to all operators. However, to minimize non-productive time of the operators any early assessments or speculations of operators handling the initial diagnosis may be input as hypothesis input to improve the speed of the operator handling a subsequent step e.g. the diagnosis output.

As described the steps of the method according to the invention may comprise further steps to increase the quality of the handling of service requests by certain subroutines. FIG. 4 shows an embodiment according to the invention wherein the step of allocating initial diagnosis input fields comprises two steps in order to force or nudge the operator to handle the initial diagnosis by indicating the symptom associated with a problem e.g. a user requesting help with his computer, since the computer keeps crashing. The problem of the service request is evidently a computer not working optimally, the symptom is that the computer keeps crashing. Since such problem and symptom may cover a wide variety of triggering factors, the operator may already in the initial diagnosis have information about a triggering factor of the symptom e.g. the user may have provided information on a specific software program associated with the crashes or loud sound indicating hardware failures etc. If the operator is able to indicate a triggering factor already in the initial diagnosis step, the handling of the service request may be sub-optimized since a given operator handling the diagnosis output may be handed only service requests requiring the specific expertise of this operator. Same approach may be used to optimize other steps or sub routines of the method.

During an operators input of the initial diagnosis input fields a specific resolution of the output may be requested and a qualified resolution may be searched to accommodate the request. Iterations may be required to achieve the requested specific resolution if the accessible resolution is inadequate e.g. maybe the generic problem was solved earlier, but the specific problem is different and must be handled differently than the accessible resolution. In such cases the operator is then required to input a qualified resolution to the specific problem or in case the problem is not solvable inputs a “no-resolution”, which may be communicated back to the requestor of the service request. This approach may furthermore be used to set up a well-organized hierarchy of qualified resolutions, which may be used systematically in future handlings of service requests.

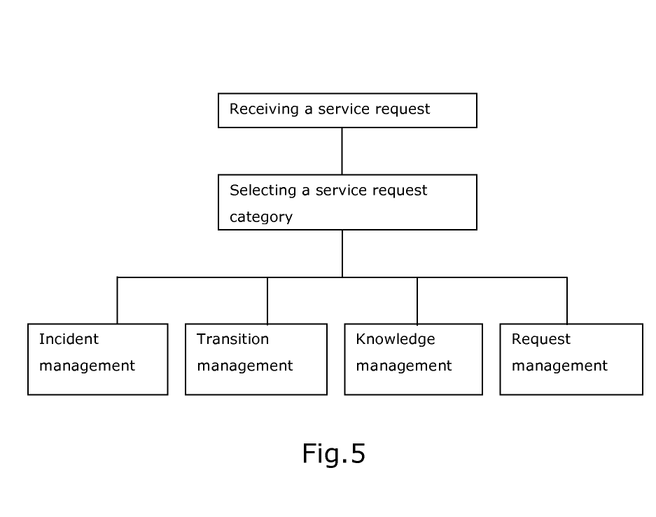

FIG. 5 is a schematic overview of a service provider management system comprising four different service request categories i.e. incident, transition, knowledge and request managements. These are not to be considered limiting to the scope of the invention, but are examples of typical categories of service requests handled in service provider management systems. Even more categories may be handled using the same method and service provider management system. Since the operator interface is controlled to primarily comprise fields intended to be handled by the operator in that particular part of the process, the operator is not affected by the system handling a wide variety of service request categories. If the operator is not well suited to fill out the required input he may forward it to the relevant operators or send it back for re-categorization. In this way the daily work of the operator may also be more convenient since stressful tasks relating to the handling of service requests outside the competences of the operator may be more or less avoided.

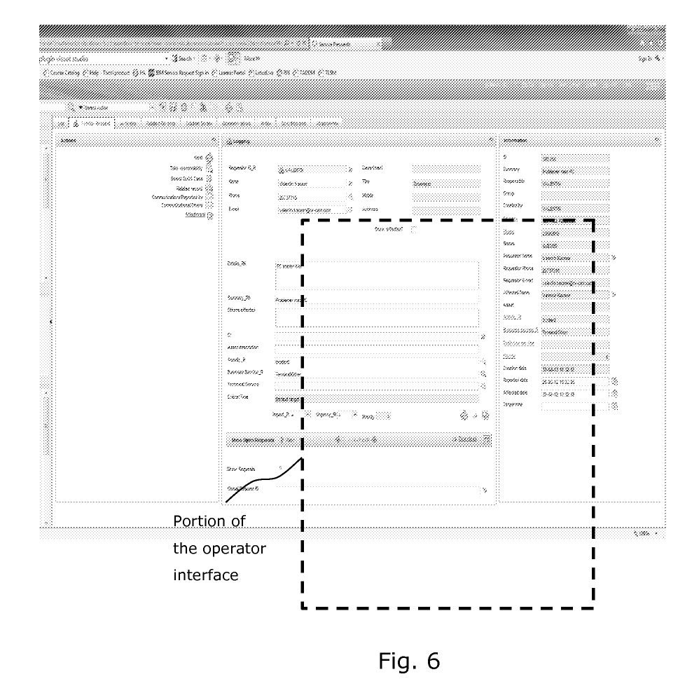

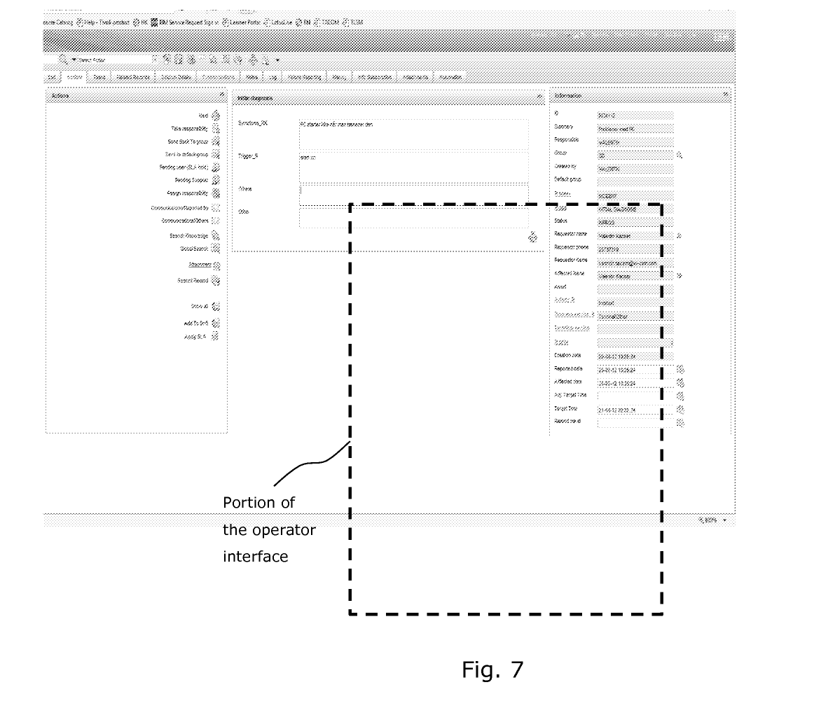

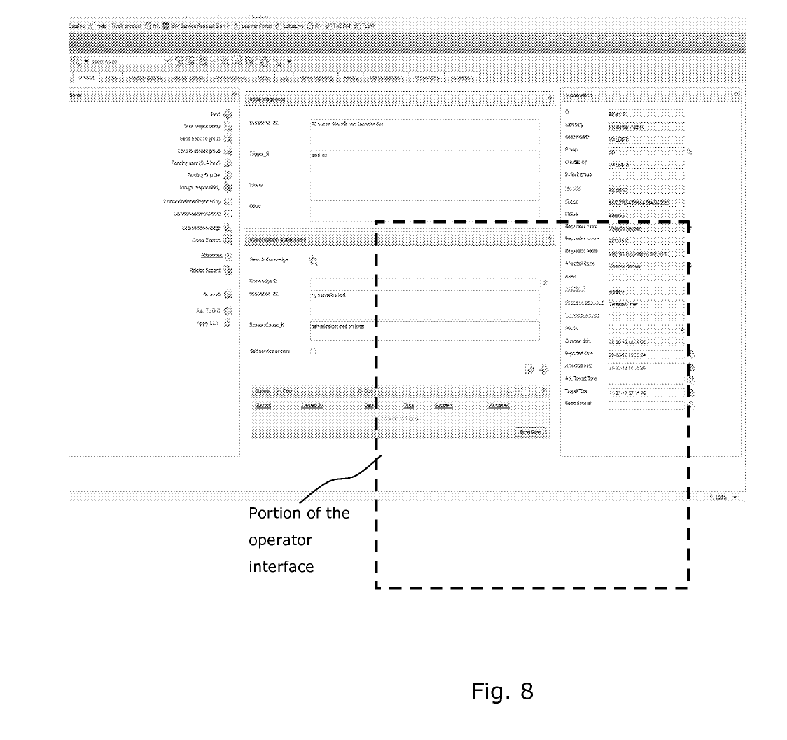

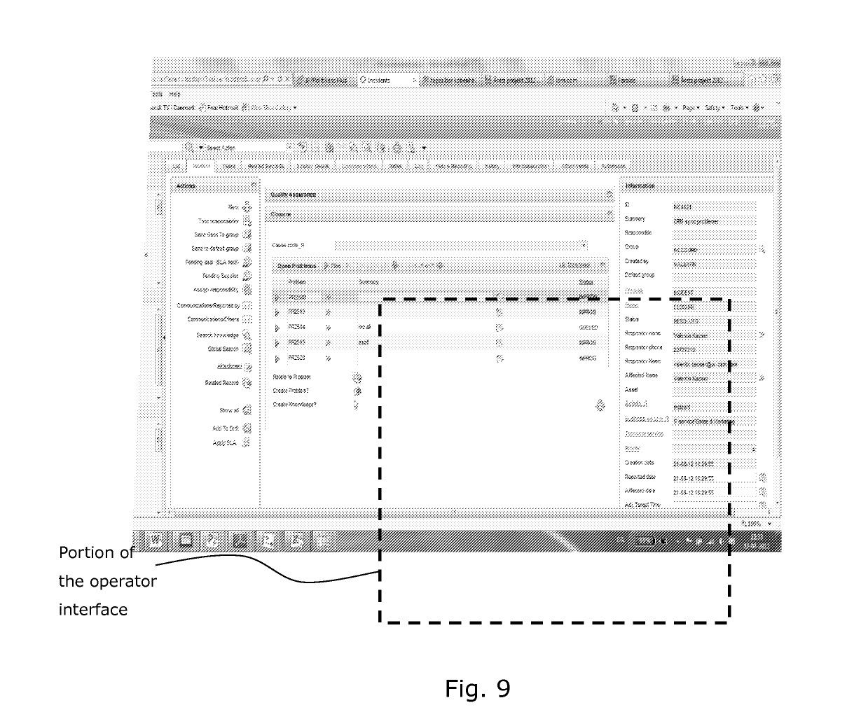

FIGS. 6-9 shows a series of screen shots of an operator interface having a central portion allocated to specific fields of interest during the process thereby controlling the operator to fill in the needed information to ensure a good, thorough and consistent processing of service requests by a service provider and a controlled collection of the knowledge build-up by earlier inquiries.

In some methods of operating service request management systems specific steps of the method may involve the requestor to input additional information required to solve certain issues with respect to the service request.

Reminders may be used in the method or systems according to the invention to remind operators or requestors to input a certain mandatory or non-mandatory input. Especially mandatory input may be ensured be specific subroutines reminding of missing input.

In some embodiments of the invention the requestor may act as operator.

The term “comprising” as used in the claims does not exclude other elements or steps. The term “a” or “an” as used in the claims does not exclude a plurality. The single processor, device or other unit may fulfill the functions of several means recited in the claims.

The reference signs used in the claims shall not be construed as limiting the scope.

Although the present invention has been described in detail for purpose of illustration, it is understood that such detail is solely for that purpose, and variations can be made therein by those skilled in the art without departing from the scope of the invention.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

1. A method of operating a service provider management system having an operator interface and an input component, said method comprising the steps of:
receiving a service request in the system from a requestor being serviced by a service provider;
allocating a portion of the operator interface to a set of predefined logging input fields comprising a set of mandatory logging input fields;
prompting an operator to input or select facts relating to the service request in the logging input fields;
verifying that mandatory logging input fields have been completed before allowing the next step to be initiated;
thereafter allocating said portion of the operator interface to a set of predefined initial diagnosis input fields, said set of predefined initial diagnosis input fields comprising mandatory initial diagnosis input fields;
prompting an operator to input or select an initial diagnosis in the set of initial diagnosis input fields;
verifying that the mandatory initial diagnosis input fields have been completed;
thereafter allocating said portion of the operator interface to a set of predefined diagnosis output fields, said set of predefined diagnosis output fields comprising mandatory diagnosis output fields;
prompting an operator to input or select a diagnosis output in the set of diagnosis output fields;
verifying that the mandatory diagnosis output fields has been completed;
issuing a service request reply comprising the diagnosis output;
thereafter allocating the portion of the operator interface to a set of closure fields comprising mandatory closure fields;
prompting an operator to input or select facts relating to closure in the set of closure fields;
verifying that the mandatory closure fields has been completed;
closing the service request; and
outputting the facts from the mandatory closure fields to a database.

2. A method according to claim 1, wherein the step of allocating a portion of the operator interface to a set of predefined logging input fields comprising a set of mandatory logging input fields further comprises the steps of:
prompting an operator to input or select a service request category;
verifying that the service request category has been input or selected, and
defining a sequence of the set of predefined logging input fields based on the service request category.

3. A method according to claim 2, wherein the service request category is an incident management, a transition management, knowledge management, change management or a request management.

4. A method according to claim 1, wherein one or more of the steps of prompting an operator to input or select facts, an initial diagnosis, a diagnosis output or facts relating to closure further comprises the step of:
nudging the operator to input or select one or more mandatory or optional fields.

5. A method according to claim 4, wherein the step of nudging the operator to input or select one or more optional fields comprises prompting the operator with information from earlier similar service requests to lessen the burden of inputting or selecting one or more optional fields thereby improving quality of the operator input.

6. A method according to claim 4, wherein the step of nudging the operator to input or select one or more mandatory or optional fields comprises prompting the operator with a direct link to a knowledge database to allow the operator quickly to seek information to lessen the burden of inputting or selecting one or more optional fields thereby improving quality of the operator input.

7. A method according to claim 4, wherein the step of nudging the operator to input or select one or more mandatory or optional fields comprises prompting the operator with information from earlier service requests to lessen the burden of inputting or selecting one or more optional fields thereby improving quality of the operator input.

8. A method according to claim 3, wherein the step of allocating a portion of the operator interface to a set of predefined logging input fields comprising a set of mandatory logging input fields further comprises the step of:
displaying in the central portion facts from one or more similar service requests in the same service request category.

9. A method according to claim 3, wherein the method further comprises the steps of:
prioritizing the service request by a service request priority;
forwarding the service request to a buffer list of service requests;
displaying a service request having the highest priority in the central portion.

10. A method according to claim 1, wherein the step of allocating said portion of the operator interface to a set of predefined initial diagnosis input fields comprises the steps of:
allocating a field for a symptom associated with a problem of the service request;
allocating a field for a triggering factor of the symptom associated with the problem.

11. A method according to claim 1, wherein the method further comprises the step of prompting the operator to input or select which inputting fields associated with logging, initial diagnosis, diagnosis output or closure are relevant to future service requests such that the input or selected information from the operator may be made available in a knowledge database.

12. A method according to claim 6, wherein the operator is prompted to tick off fields of relevance in a tick box associated with each fields, thereby indicating fields which are relevant to future service requests such that the ticked input from the operator may be made available a knowledge database.

13. A method according to claim 1, wherein the step of allocating said portion of the operator interface to a set of predefined diagnosis output fields further comprises the step:
allocating a direct link to a knowledge database in the portion of the operator interface;

14. A method according to claim 1, wherein the step of allocating the portion of the operator interface to a set of closure fields comprising mandatory closure fields further comprises the step:
allocating a field for a case summary;

15. A method according to claim 1, wherein the steps of verifying that the mandatory logging fields, mandatory initial diagnosis fields, diagnosis output fields has been completed comprises a step of prompting to the operator that the service request cannot be issued before the mandatory fields has been completed.

16. A method according to claim 5, wherein the step of allocating the portion of the operator interface to a set of closure fields comprises the step of:
allocating a field for a list of open service request having matching or near matching symptoms or triggering factors of the symptoms of a problem of the service request for allowing the operator to solve similar service requests while having the service request and diagnosis steps fresh in mind.

17. A method according to any of claim 1, wherein allocation of said portion of the operator interface is shown on a graphical user interface on a computer screen and said operator input component comprises a keyboard.

18. A method according to claim 1, wherein input or selection values of a service request already known in the service management system are automatically discarded and thus not prompted to be input by the operator.

19. A computer-based service provider management system comprising:
an operator interface and an input component;
a processor being configured to control operation of said system including being configured to receive input from an operator through the input component, and to run an application on said system;
said processor further being configured to receive a service request in the system from a requestor being serviced by a service provider;
said processor further being configured to allocate a portion of the operator interface to a set of predefined logging input fields comprising a set of mandatory logging input fields;
said processor further being configured to prompt an operator to input or select facts relating to the service request in the logging input fields;
said processor further being configured to verify that mandatory logging input fields has been completed before allowing the next step to be initiated;
said processor further being configured to thereafter allocate said portion of the operator interface to a set of predefined initial diagnosis input fields, said set of predefined initial diagnosis input fields comprising mandatory initial diagnosis input fields;
said processor further being configured to prompt an operator to input or select an initial diagnosis in the set of initial diagnosis input fields;
said processor further being configured to verify that the mandatory initial diagnosis input fields has been completed;
said processor further being configured to thereafter allocate said portion of the operator interface to a set of predefined diagnosis output fields, said set of predefined diagnosis output fields comprising mandatory diagnosis output fields;
said processor further being configured to prompt an operator to input or select a diagnosis output in the set of diagnosis output fields;
said processor further being configured to verify that the mandatory diagnosis output fields has been completed;
said processor further being configured to issue a service request reply comprising the diagnosis output;
said processor further being configured to thereafter allocate the portion of the operator interface to a set of closure fields comprising mandatory closure fields;
said processor further being configured to prompt an operator to input or select facts relating to closure in the set of closure fields;
said processor further being configured to verify that the mandatory closure fields have been completed;
said processor further being configured to close the service request.

20. A system according to claim 14, wherein said processor is furthermore configured to categorize the service request by a service request category and configured to define a sequence of the set of predefined logging input fields based on the service request category.

21. A system according to claim 14, wherein said processor is furthermore configured to display in the central portion facts from one or more similar service requests in the same service request category during allocation of the central portion of the predefined area of the operator interface to the set of predefined logging input fields.

22. A system according to claim 14, wherein said processor is configured to prioritize the service request by a service request priority, forward the service request to a buffer list of service requests and display a service request having the highest priority in the central portion.

23. A system according to claim 14, wherein said processor is configured to prioritize the service request by a service request priority, forward the service request to a buffer list of service requests and display a service request having the highest priority in the central portion.

24. A system according to claim 14, wherein said processor is configured to allocate a field for a symptom of a problem of the service request and allocate a field for a triggering factor of the symptom of the problem during allocation of the central portion to the set of predefined initial diagnosis input fields.

25. A system according to claim 14, wherein said processor furthermore is configured to receive inputs from of the operator, when the operator is inputting in fields associated with logging, initial diagnosis, diagnosis output or closure, the inputs indicating fields which are relevant to future service requests such that the indicated input from the operator may automatically enter a knowledge database.

26. A system according to claim 14, wherein said processor furthermore is configured to receive inputs from of the operator, when the operator is inputting in fields associated with logging, initial diagnosis, diagnosis output or closure, said processor being configured to receive an operator ticking off fields indicating fields which are relevant to future service requests in a ticking box associated with each field such that the ticked input from the operator may automatically enter a knowledge database.

27. A system according to claim 14, wherein said processor is configured to allocate a direct link to a knowledge database in the central portion during allocation of the central portion to a set of diagnosis output fields.

28. A system according to claim 14, wherein said processor is configured to allocate a field for a case summary during allocation of the central portion to a set of diagnosis output fields.

29. A system according to claim 14, wherein said processor is configured to allocate a field for a list of open service request having matching or near matching symptoms or triggering factors of the symptoms of a problem of the service request during allocation of the central portion to a set of closure fields.

30. A system according to claim 14, wherein said processor is configured to give access to input data from a set of fields having been recognized by a control procedure during subsequent steps.
